(19) United States
(12) Patent Application Publication
(10) Pub. No.: US 2013/0254771 A1
(43) Pub. Date: Sep. 26, 2013

(54) SYSTEMS AND METHODS FOR CONTINUAL, SELF-ADJUSTING BATCH PROCESSING OF A DATA STREAM

(71) Applicant: GOOGLE INC., Mountain View, CA (US)

(72) Inventors: Eldar A. Musayev, Sammamish, WA (US); Nikunj Bhagat, Bellevue, WA (US); Ian Porteous, Mercer Island, WA (US); Laramie J. Leavitt, Kirkland, WA (US); Matthew Nichols, Woodinville, WA (US)

(73) Assignee: GOOGLE INC., Mountain View, CA (US)

(21) Appl. No.: 13/726,958

(22) Filed: Dec. 26, 2012

Related U.S. Application Data
(60) Provisional application No. 61/613,405, filed on Mar. 20, 2012.

(51) Int. Cl. G06F 9/46

(52) U.S. Cl. CPC G06F 9/466
USPC 718/101

(57) ABSTRACT

Methods, systems and apparatus are described herein that include processing a data stream as a sequence of batch jobs during collection of data in the data stream. Processing of successive batch jobs in the sequence includes creating a particular batch job upon completion of processing of a preceding batch job in the sequence. The particular batch job has a batch size that depends upon an amount of data in the data stream that has been collected since creation of the preceding batch job in the sequence, such that the batch size of the particular batch job self-adjusts to data rate changes in the data stream. The particular batch job is then processed to produce resulting data, where processing efficiency and processing time for the particular batch increase with the batch size.

### RELATED APPLICATIONS

This application claims priority under 35 U.S.C. §119 to Provisional Patent Application Ser. No. 61/613,405, entitled “SYSTEMS AND METHODS FOR CONTINUAL, SELF-ADJUSTING BATCH PROCESSING OF A DATA STREAM” filed on Mar. 20, 2012. The subject matter of this earlier filed application is hereby incorporated by reference.

### BACKGROUND

The present disclosure relates to data processing. In particular, it relates to techniques for efficiently processing large amounts of data in a data stream during collection of the data stream.

Information retrieval systems, such as Internet search engines, are responsive to a user's query to retrieve information about accessible documents such as web pages, images, text documents and multimedia content. A search engine locates and stores the location of documents and various descriptions of the information in a searchable index used to facilitate fast information retrieval. The search engine may use a variety of statistical measures to determine the relevance of the documents in the index to the user's query, and provides these relevant documents as search results.

The relevance of the documents to the user's query may be based at least in part on prior user responses to the search results. However, as new and updated documents are included in the index, while other documents are no longer available and removed from the index, the prior user responses can quickly become out-of-date. As a result, a high latency between when new user responses are available, and when they are reflected in the search results rankings, can result in search results being provided that include a number of documents that are no longer the most relevant to a user's query.

Reducing the latency is challenging because of the large amount of data to be processed, as well as the changes in the rate of the user responses due to fluctuations in the number of users over time. In an attempt to overcome or alleviate the problems associated with high latency, a vast amount of computing resources may be utilized or reserved. However, in order to ensure that sufficient computing resources are available to process periods of high data rates, a significant portion of these computing resources may primarily be idle. This approach is both expensive and inefficient.

### SUMMARY

The present disclosure relates to systems and methods for processing a data stream in near real-time in a manner that enables efficient, cost effective use of available computing resources. In one implementation, a method is described that includes processing a data stream as a sequence of batch jobs during collection of data in the data stream. Processing of successive batch jobs in the sequence includes creating a particular batch job upon completion of processing of a preceding batch job in the sequence. The particular batch job has a batch size that depends upon an amount of data in the data stream that has been collected since creation of the preceding batch job in the sequence, such that the batch size of the particular batch job self-adjusts to data rate changes in the data stream. The processing of successive batch jobs further includes processing the particular batch job to produce resulting data. The processing of the particular batch job is such that processing efficiency and processing time increase with the batch size.

This method and other implementations of the technology disclosed can each optionally include one or more of the following features.

The data stream can be collected in a plurality of files. Creating the particular batch job can include opening the plurality of files. The particular batch job can then be formed by reading data that has been written to the plurality of opened files since the creation of the preceding batch job in the sequence. The plurality of opened files can then be closed. This method can then be further extended by reading the data from the plurality of opened files in a predetermined data block size.

The particular batch job can include substantially all of the data in the data stream that has been collected since the creation of the preceding batch job in the sequence, such that the processing of the data stream after a number of batch jobs in the sequence converges towards a steady state processing time for a given data rate for the data stream.

The data in the data stream can include search session data associated with search queries received from users, and can be collected in a plurality of records. Creating the particular batch job can include reading data that has been written to the records since creation of the preceding batch job in the sequence.

Substantially all of the data that has been written to the records since creation of the preceding batch job in the sequence can be read to create the particular batch job.

The records can include a first set of one or more records maintained by a first search engine server, and a second set of one or more records maintained by a second search engine server.

The method can include providing the resulting data to a search engine for use in modifying search results.

The processing of batch jobs in the sequence can be performed using a fixed amount of computing resources.

The method can include monitoring processing time for completing the processing of respective batch jobs in the sequence. Additional computing resources can then be provisioned for use in processing subsequent batch jobs in the sequence if the processing time for a given batch job exceeds a threshold value.

The processing of successive batch jobs can occur without waiting a minimum amount of time.

The resulting data may be derived from but differ from the data in the data stream.

In another aspect, a method includes receiving a real-time stream of data records and processing a first portion of the data records in a first batch job to produce resulting data. The resulting data may be derived from the first portion of the data records as a result of the processing. The method may also include processing a second portion of the real-time data in a subsequent batch job that is initiated by completion of the first batch job, the second portion of the real time data records including data records collected during processing of the first batch job. In some implementations, the real-time stream of data records includes records from a first file from a first search engine server, and records from a second file from a second search engine server:

Other implementations may include a non-transitory computer readable storage medium storing instructions executable by a processor to perform a method as described above. Yet another implementation may include a system including memory and one or more processors operable to execute instructions, stored in the memory, to perform a method as described above.

Particular implementations of the subject matter described herein enable efficient, cost-effective use of computing resources to process a data stream in near real-time. The data stream is processed in a continual batch mode by repeatedly creating and processing batch jobs of data being collected from the stream. The batch jobs are created in a serial fashion that allows for the continual utilization of the available computing resources, which reduces or eliminates idle resource time. In addition, the processing throughput can be scaled to match the amount of data that needs to be processed, by dynamically adjusting the processing efficiency. This adjustment can be achieved by self-adjusting the batch sizes based upon an amount of data that has been collected since creation of the immediately preceding batch job. This is turn enables the data to be processed in larger batches that are more efficient, which compensates for increases in the data rate, or for pauses that result in a backlog of unprocessed data. The techniques described herein thus provide the flexibility to efficiently process large amounts of data when needed, without having to reserve a vast amount of primarily idle computing resources. As a result, the batch processing techniques described herein can achieve continual resource utilization, in a manner that converges towards a minimal latency given the amount of the data to be processed and the amount of available computing resources.

Particular aspects of one or more embodiments of the subject matter described in this specification are set forth in the drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which continual batch processing of a data stream can be used.

FIG. 2 is a block diagram illustrating example modules within the batch processing engine.

FIG. 3 is a flow chart illustrating an example continual batch process for processing a data stream as a sequence of batch jobs.

FIG. 4 illustrates an example timing diagram of a sequence batch jobs demonstrating the effect the processing time of a preceding batch has on the batch size of a subsequent batch.

FIG. 5 illustrates a graph of example batch processing times for continual batch jobs in the sequence.

FIG. 6 is a block diagram of an example computer system.

### DETAILED DESCRIPTION

Technology described herein processes a data stream in near real-time, in a manner that enables efficient, cost-effective use of available computing resources such as processors, memory, storage and other hardware and software resources. The data stream is processed in a continual batch mode by repeatedly creating and processing batch jobs of data collected from the stream, without manual intervention. A batch job refers to the concurrent processing of data collected in a group of files.

The batch jobs are created in a serial fashion to allow for the continual utilization of the available computing resources, which reduces or eliminates idle resource time. In addition, the continual batch mode allows the processing throughput to be scaled to match the amount of data that needs to be processed, by dynamically adjusting the processing efficiency. The processing efficiency is the rate at which data is processed per unit time.

The adjustment in processing efficiency is achieved by self-adjusting the batch size based upon an amount of data that has been collected since creation of the immediately preceding batch job. This is turn enables the data to be processed in larger batch sizes that are more efficiently processed, which compensates for increases in the data rate, or for pauses that result in a backlog of unprocessed data.

The processing efficiency increases with batch size, because the processing throughput increases more rapidly than the increase in the batch processing time. The increase in processing efficiency with batch size can be achieved at least in part due to the reduction in the number of file open/file close operations that are performed during the processing of a particular amount of data. For example, processing a group of 50,000 files as a single 10 Gb batch job, results in 50,000 file open operations and 50,000 file close operations. In contrast, processing that same 10 GB as two sequential 5 Gb batch jobs will result in 50,000 file open operations and 50,000 file close operations for each 5 Gb batch job, or a total of 100,000 file open operations and 100,000 file close operations to process the same 10 Gb of data.

That is, processing a given amount of data as two smaller batch jobs instead of one larger batch job, doubles the number of file open operations and file close operations. These additional file open operations and file close operations take considerable amounts of time. As a result, the total time to process a single 10 Gb batch job can be significantly less that the total time to process two sequential 5 Gb batch jobs, albeit with an increased latency between when the first of the 10 Gb of data is available for processing, and when the resulting data is available.

Further increases in processing efficiency with batch size can also be achieved in instances in which the data is read from the files using a predetermined data block size. For example, assume that data is collected in a file at a rate of 1 Mb/min, and is read from the file in 4 Mb blocks. If the data is read every five minutes, the 5 Mb of data will be read in two 4 Mb blocks, and 1 Mb from the last block will be used. That is, reading 10 Mb of data as two 5 Mb chucks for use in separate batch jobs will result in four block read operations being performed. In contrast, if the data is read every ten minutes, 10 Mb of data will be read in three 4 Mb blocks, and 2 Mb from the last block will be used. That is, reading 5 Mb twice as often as reading 10 Mb of data will result in an additional block read operation being performed. Over a large number of files, this additional block read operation can take considerable amounts of time. In this example, the data block size is 4 Mb. Alternatively, the data block size may be different than 4 Mb.

The batch processing techniques described herein thus automatically manage a balance between processing throughput and latency, by increasing the processing efficiency when needed, albeit at the expense of an increased latency. This provides the flexibility to efficiently process large amounts of data when needed, without having to reserve vast amounts of primarily idle resources. As a result, the techniques described herein can achieve continual resource utilization, in a manner that converges to a minimal latency given the amount of data to be processed and the available computing resources.

In examples described herein, the data stream that is processed corresponds to user search session data that is continually written to records by search engine servers. The resulting data of the batch processing can then be used by the search engine servers to modify the rankings of documents within subsequent search results provided to users. More generally, the batch processing techniques described herein can be utilized to efficiently process data streams that correspond to other types of data.

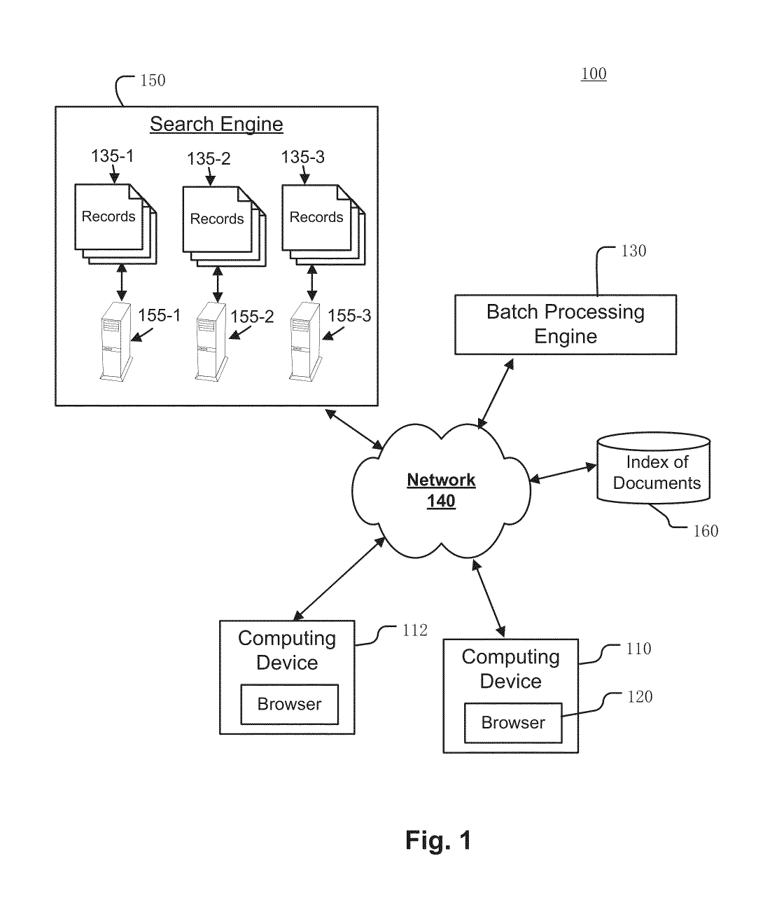

FIG. 1 illustrates a block diagram of an example environment 100 in which the continual batch processing of a data stream can be used. The environment includes client computing devices 110, 112 and a search engine 150. The environment 100 also includes a communication network 140 that allows for communication between the various components of the environment 100.

During operation, users interact with the search engine 150 through the client computing devices 110, 112. The client computing devices 110, 112 each include memory for storage of data and software applications, a processor for accessing data and executing applications, and components that facilitate communication over the communication network 140. The computing devices 110, 112 execute applications, such as web browsers (e.g. web browser 120 executing on client computing device 110), that allow users to formulate search queries and submit them to the search engine 150. The search engine 150 receives queries from the computing devices 110, 112, and executes the queries against an index of documents 160 such as web pages, images, text documents and multimedia content. The search engine 150 identifies content which matches the queries, and responds by generating search results which are transmitted to the computing devices 110, 112 in a form that can be presented to the users. For example, in response to a query from the computing device 110, the search engine 150 may transmit a search results web page to be displayed in the web browser 120 executing on the computing device 110.

As shown in FIG. 1, the search engine 150 includes a number of search engine servers 155-1 to 155-3 that receive queries from various users and provide search results in response. The search engine servers 155-1 to 155-3 provide redundancy, and may be geographically distributed. In the illustrated example, three search engine servers 155-1 to 155-3. It will be understood that the search engine 150 can include many more than three search engine servers 155.

The search engine server 155-1 may maintain records 135-1 of user search session data associated with queries received from prior users. The records 135-1 may be collectively stored on one or more computers and/or storage devices. During operation, data is continually written to the records 135-1 by the search engine server 155-1 based on user responses to the search results. The data that is written to the records 135-1 may include information such as which results were selected by users after a search was performed on a particular query, and how long each search result was viewed by a user.

Similarly, the search engine server may 155-2 maintain records 135-2, and search engine server 155-3 may maintain records 135-3. The records 135-1, 135-2 and 135-3 may each be maintained independent of one another.

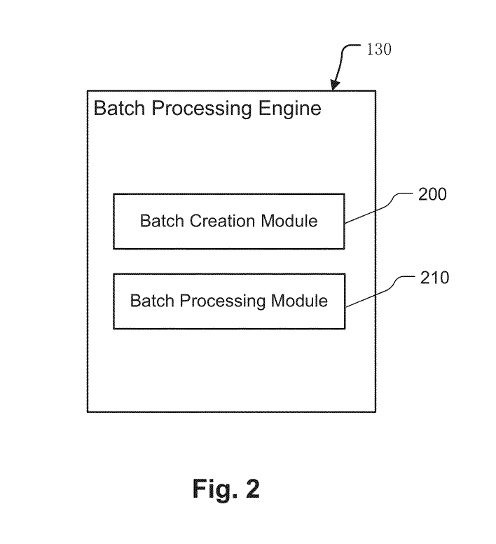

The environment 100 may also include a batch processing engine 130. The data stream that is continually being written to the records 135-1 to 135-3 may be processed by the batch processing engine 130 using the techniques described herein. The batch processing engine 130 can be implemented in hardware, firmware, or software running on hardware. The batch processing engine 130 is described in more detail below with reference to FIGS. 2-6.

As described in more detail below, the search engine 150 can use the resulting data processed by the batch processing engine 130 to modify the ranking of documents in subsequently provided search results to users. For example, the resulting data processed by the batch processing engine 130 may indicate the number of unique users who have submitted a given query, the results that were selected by users, etc. More generally, the search engine 150 may use the resulting processing data for other purposes.

The network 140 facilitates communication between the various components in the environment 100. In some implementations, the network 140 includes the Internet. The network 140 can also utilize dedicated or private communications links that are not necessarily part of the Internet. In some implementations, the network 140 uses conventional or other communications technologies protocols, and/or inter-process communication techniques.

Many other configurations are possible having more or less components than the environment 100 shown in FIG. 1. For example, the environment 100 can include multiple search engines. The environment 100 can also include many more computing devices that submit queries to many more search engine servers.

FIG. 2 is a block diagram illustrating example modules within the batch processing engine 130. In FIG. 2, the batch processing engine 130 includes a batch creation module 200, and a batch processing module 210. Some implementations may have different and/or additional modules than those shown in FIG. 2. Moreover, the functionalities can be distributed among the modules in a different manner than described here.

The batch creation module 200 manages the creation of batch jobs for use in continually processing the data stream collected in the records 135-1 to 135-3. A given batch job is created by opening the records 135-1 to 135-3, reading new data that has been written to the records 135-1 to 135-3 to form the batch job, and then closing the records 135-1 to 135-3. In some implementations, the batch job is created by reading substantially all of the data that has been collected in the records 135-1 to 135-3 since the creation of a preceding batch job. As used herein, the term “substantially” is intended to accommodate data that is collected prior to the beginning of the processing of the current batch job, but that is collected too late to include in the current batch job. This may result in a slight difference between the amount of the data in current batch job, and the amount of data collected since creation of the preceding batch job.

The created batch job is then processed by the batch processing module 210 to produce resulting data. The batch processing module 210 includes computing resources such as processors, memory, communications, storage and other hardware and software resources associated with processing the batch jobs. The operations performed on the collected data by the batch processing module 210 to produce the resulting data may vary from implementation to implementation.

Upon completion of the processing of a batch job, the batch processing module 210 transmits the resulting data to the search engine 150. This resulting data indicates the search queries submitted by users, as well as the user response to the search results provided by the various search engine servers 155-1 to 155-3. The search engine 150 can then use this data to modify the ranking of documents in subsequently provided search results to users. For example, the search engine 150 may use this data to update search quality scores associated with the documents and used to determine the rankings.

Upon completion, the batch processing module 210 notifies the batch creation module 200, so that the batch creation module 200 can create a new batch job for processing.

In some implementations, the amount of computing resources used by the batch processing engine 130 to process the batch jobs are fixed. These computing resources can generally include processors, memory, storage and other hardware and software resources. In such a case, increases in the processing throughput to compensate for increases in the data rate, or pauses that result in a backlog of unprocessed data, are achieved via the increase in processing efficiency with increased batch size.

In other implementations, the batch processing module 210 may also monitor processing time for completing the processing of the batch jobs in the sequence. The batch processing module 210 then provisions additional computing resources for use in processing subsequent batch jobs in the sequence if the processing time for a given batch job exceeds a threshold value. In such a case, the provisioned resources can further increase the processing throughput over that provided by the increased batch size. These provisioned resources may for example be provisioned utilizing a ‘cloud’ computing environment.

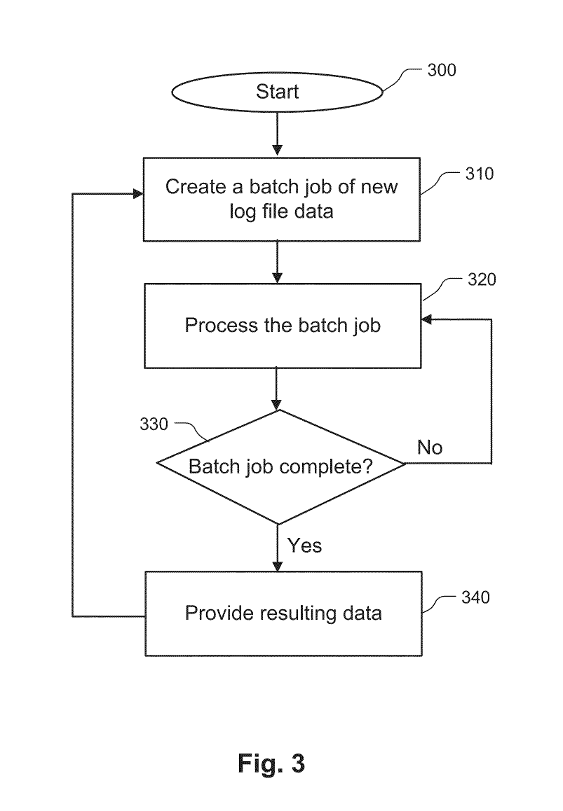

FIG. 3 is a flow chart illustrating an example continual batch process for use in processing a data stream as a sequence of batch jobs during collection of the data. Other implementations may perform the steps in different orders and/or perform different or additional steps than the ones illustrated in FIG. 3. For convenience, FIG. 3 will be described with reference to a system of one or more computers that performs the process. The system can be, for example, the batch processing engine 130 described above with reference to FIG. 1.

The process begins at step 300. The process may be initiated for example upon a decision to begin the batch processing operation. This decision may, for example, be made upon deployment of the batch processing engine 130.

At step 310, the system creates a batch job. The batch job is created by opening the records 135-1 to 135-3, reading new data that has been written to the records 135-1 to 135-3 to form the batch job, and then closing the records 135-1 to 135-3.

At step 320, the system processes the created batch job, and waits for the processing of the batch job to be completed at step 330. Following the completion of the processing of the batch job, the system continues to step 340. At step 340, the system provides the resulting data to the search engine 150 for use in modifying the search result rankings.

The process then continues back to step 310, where a new batch job is created. The new batch job is created by opening the records 135-1 to 135-3, reading the data that has been written to the records 135-1 to 135-3 since creation of the preceding batch job, and then closing the records 135-1 to 135-3. The new batch job is then processed at steps 320, 330 using the same computing resources that processed the first batch job, and the resulting data is provided to the search engine at step 340.

The process then continues in the loop of steps 310, 320, 330, 340 to repeatedly create and process the sequence of batch jobs.

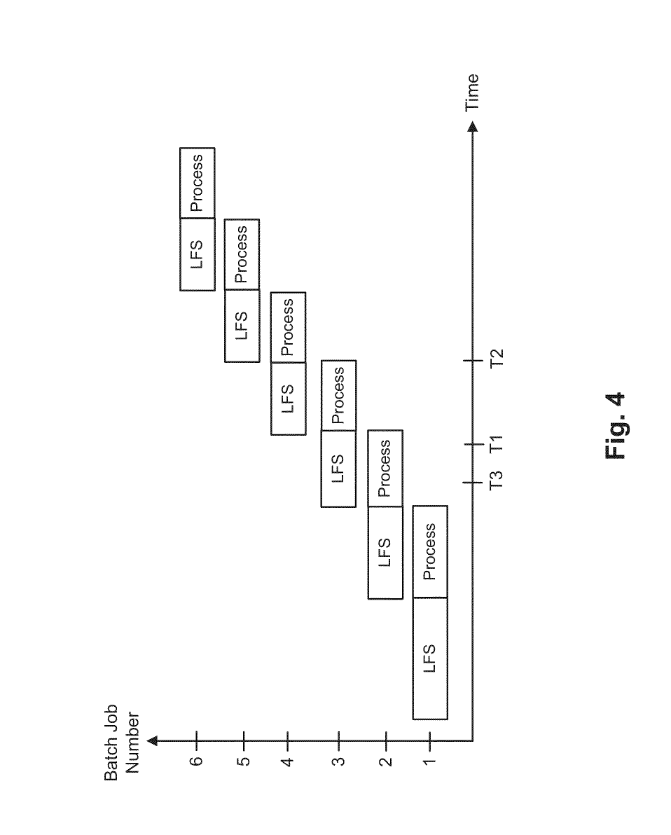

FIG. 4 is a timing diagram of a sequence of batch jobs. The period of time that data is collected in the records and extracted for use in creating a given batch job is the Log Files Scanner process, labeled “LFS” in FIG. 4. During the LFS process, new data in the records is extracted during the processing of a preceding batch job. In some implementations, the LFS process is omitted, and the data is extracted upon completion of the processing of the preceding batch job.

The period of time to process a given batch job is labeled “Process” in FIG. 4. As shown in FIG. 4, the data for a given batch job is collected during the processing of a preceding batch job, and then is created and processed upon completion of the preceding batch job. As a result, the batch size of the given batch job depends upon the processing time of the preceding batch job, such that the batch size of the given batch job can self-adjust to data rate changes in the data stream during this processing.

The latency of collected data depends on the processing time of the batch job that includes this data, as well as the period of time between when the data was collected and when the preceding batch job is completed. For example, the data collected at time T1 during the processing of batch job #2, will be included in batch job #3, and the resulting data will be produced at time T2 upon completion of the processing of batch job #3. Data collected at time T3 will also be included in batch job #3, and the resulting data will be available upon completion of the processing the batch job #3 at time T2. As a result, the data collected at time T1 has a smaller latency (T2−T1) than the latency (T2−T3) of the data collected at time T3, despite being included in the same batch job.

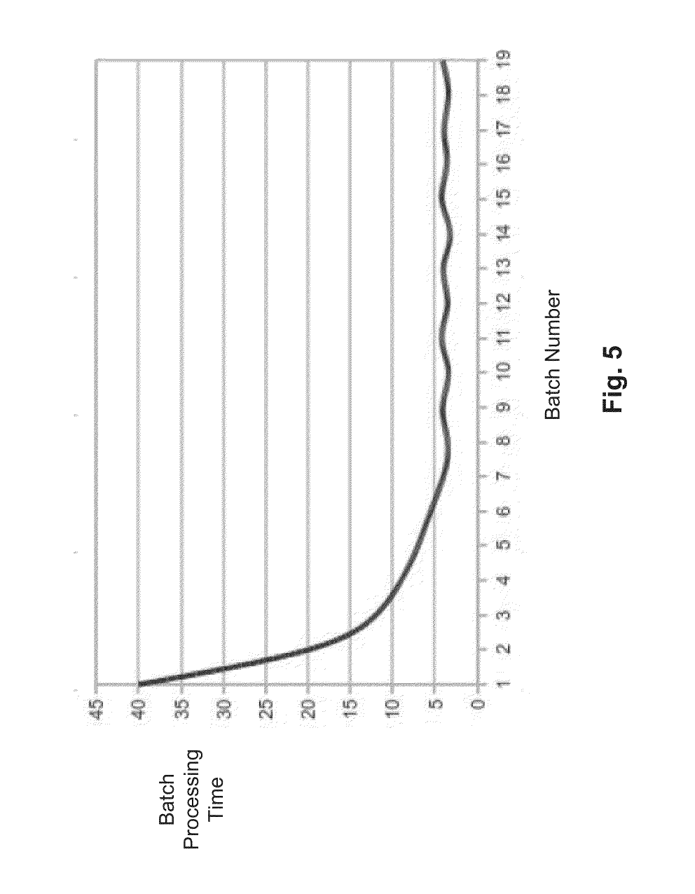

FIG. 5 illustrates a graph of batch processing time demonstrating the processing “catching-up” with the data stream following a pause in the processing. In FIG. 5, the continual batch processing starts following a pause which resulted in a backlog of unprocessed data. As a result, the batch size and the resulting processing time of the first batch in the sequence is rather large. Since the second batch job is created upon completion of the first batch job, it has a batch size that depends on the amount of data that has been collected in the records 135-1 to 135-3 since the creation of the first batch.

As shown in FIG. 5, as a consequence of the increased processing efficiency with increasing batch size, the batch processing time decreases for subsequent batch jobs until the processing “catches-up” with the data stream being collected. In this example, a particular batch job includes substantially all of the data that has been collected since the creation of the preceding batch job in the sequence. As a result, the processing of the data stream after a number of batch jobs in the sequence converges to a steady state processing time for a given data rate for the data stream. In this example, the steady state processing time is about 4 minutes. Upon converging, the batch processing will oscillate around an equilibrium that provides continual resource utilization, with a minimal latency for the available computing resources and the existing data stream.

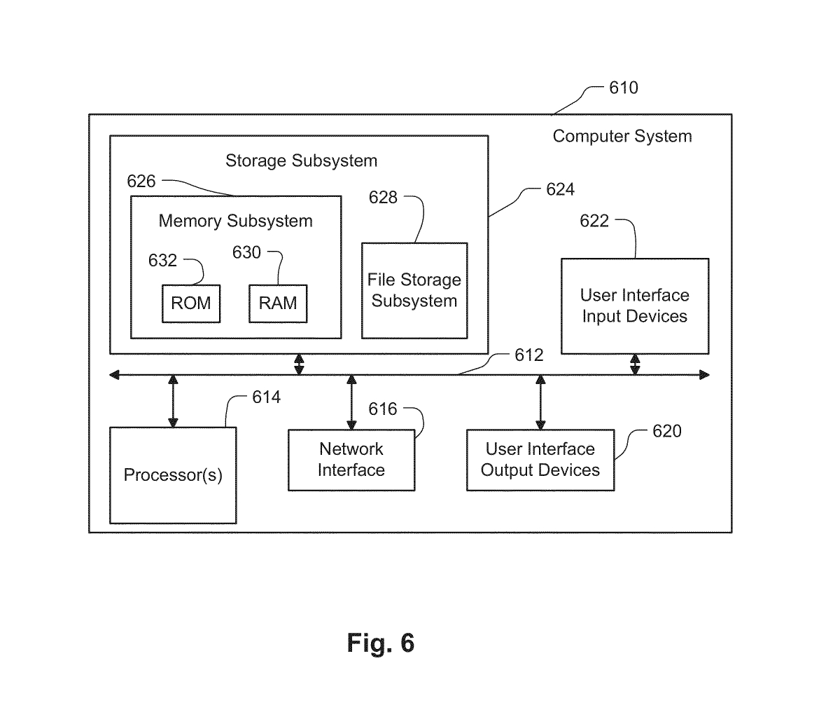

FIG. 6 is a block diagram of an example computer system. Computer system 610 typically includes at least one processor 614 which communicates with a number of peripheral devices via bus subsystem 612. These peripheral devices may include a storage subsystem 624, comprising for example memory devices and a file storage subsystem, user interface input devices 622, user interface output devices 620, and a network interface subsystem 616. The input and output devices allow user interaction with computer system 610. Network interface subsystem 616 provides an interface to outside networks, including an interface to communication network 140, and is coupled via communication network 140 to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and other types of input devices. In general, use of the term “input device” is intended to include possible types of devices and ways to input information into computer system 410 or onto communication network 618.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein, including the logic to batch processing of a data stream according to the techniques described herein. These software modules are generally executed by processor 614 alone or in combination with other processors.

Memory 626 used in the storage subsystem can include a number of memories including a main random access memory (RAM) 630 for storage of instructions and data during program execution and a read only memory (ROM) 632 in which fixed instructions are stored. A file storage subsystem can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem in the storage subsystem 424, or in other machines accessible by the processor.

Bus subsystem 612 provides a mechanism for letting the various components and subsystems of computer system 610 communicate with each other as intended. Although bus subsystem 612 is shown schematically as a single bus, alternative embodiments of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for illustrative purposes. Many other configurations of computer system 610 are possible having more or less components than the computer system depicted in FIG. 6.

While the present technology is disclosed by reference to the embodiments and examples detailed above, it is understood that these examples are intended in an illustrative rather than in a limiting sense. Computer-assisted processing is implicated in the described embodiments. Accordingly, the present technologies may be embodied in methods for identifying video content corresponding to a video bibliographic entry, systems including logic and resources to process a data stream, systems that take advantage of computer-assisted methods for processing a data stream, non-transitory, computer readable media impressed with logic to process a data stream, data streams impressed with logic to process a data stream, or computer-accessible services that carry out computer-assisted methods to process a data stream. It is contemplated that other modifications and combinations will be within the scope of the following claims.

What is claimed is:

1. A method comprising:
processing a data stream as a sequence of batch jobs during real-time collection of data in the data stream, the data stream being a plurality of files and wherein processing successive batch jobs in the sequence comprises:
creating a particular batch job upon completion of processing of a preceding batch job in the sequence, wherein the particular batch job has a batch size that depends upon an amount of data in the plurality of files of the data stream that has been collected since creation of the preceding batch job in the sequence, such that a size of the particular batch job self-adjusts to data rate changes in the data stream; and
processing the particular batch job to produce resulting data, wherein processing efficiency and processing time for the particular batch increase with the batch size.

2. The method of claim 1, wherein creating the particular batch job comprises:
opening the plurality of files;
forming the particular batch job by reading data that has been written to the plurality of opened files since the creation of the preceding batch job in the sequence; and
closing the plurality of opened files.

3. The method of claim 2, wherein the data is read from the plurality of opened files in a predetermined data block size.

4. The method of claim 1, wherein the particular batch job includes substantially all of the data in the plurality of files of the data stream that has been collected since the creation of the preceding batch job in the sequence, such that the processing of the data stream after a number of batch jobs in the sequence of batch jobs converges towards a steady state processing time for a given data rate for the data stream.

5. The method of claim 1, wherein:
data in the data stream includes search session data associated with search queries received from users, and is collected in a plurality of records; and
creating the particular batch job comprises reading data that has been written to the records since creation of the preceding batch job in the sequence.

6. The method of claim 5, wherein the records include a first set of one or more records maintained by a first search engine server, and a second set of one or more records maintained by a second search engine server and the method further comprises providing the resulting data to a search engine for use in modifying search results.

7. The method of claim 1, wherein processing successive batch jobs occurs without waiting a minimum amount of time.

8. The method of claim 1, wherein the resulting data is derived from but differs from the data in the data stream.

9. The method of claim 1, further comprising:
monitoring processing time for completing the processing of respective batch jobs in the sequence; and
provisioning additional computing resources for use in processing subsequent batch jobs in the sequence if the processing time for a given batch job exceeds a threshold value.

10. A system comprising:
at least one processor; and
a memory storing instructions that, when executed, cause the system to perform operations comprising:
processing a data stream as a sequence of successive batch jobs during collection of data in the data stream, the data stream being a plurality of files, and the sequence of batch jobs starting upon completion of a preceding batch job, wherein processing successive batch jobs in the sequence comprises instructions that cause the system to:
create a particular batch job upon completion of processing of a preceding batch job in the sequence, wherein the particular batch job has a batch size that depends upon an amount of data in the plurality of files of the data stream that has been collected since creation of the preceding batch job in the sequence, such that a size of the particular batch job self-adjusts to data rate changes in the data stream; and
process the particular batch job to produce resulting data, wherein processing efficiency and processing time for the particular batch increase with the batch size.

11. The system of claim 10, wherein the instructions that cause the system to create the particular batch job comprise instructions to:
open the plurality of files;
form the particular batch job by reading data that has been written to the plurality of opened files since the creation of the preceding batch job in the sequence; and
close the plurality of opened files.

12. The system of claim 11, wherein the data is read from the plurality of opened files in a predetermined data block size.

13. The system of claim 10, wherein the particular batch job includes substantially all of the data in the plurality of files of the data stream that has been collected since the creation of the preceding batch job in the sequence, such that the processing of the data stream after a number of batch jobs in the sequence of batch jobs converges towards a steady state processing time for a given data rate for the data stream.

14. The system of claim 10, wherein:
data in the data stream includes search session data associated with search queries received from users; and
the instructions that cause the system to create the particular batch job comprises instructions that cause the system to read data that has been written to the plurality of files since creation of the preceding batch job in the sequence without waiting a minimum amount of time.

15. The system of claim 14, wherein the plurality of files include a first file of one or more records maintained by a first search engine server, and a second file of one or more records maintained by a second search engine server.

16. The system of claim 14, the instructions further causing the system to provide the resulting data to a search engine for use in modifying an index.

17. The system of claim 10, wherein the processing of batch jobs in the sequence is performed using a fixed amount of computing resources.

18. The system of claim 10, the instructions further causing the system to perform operations comprising:
monitoring processing time for completing the processing of respective batch jobs in the sequence; and
provisioning additional computing resources for use in processing subsequent batch jobs in the sequence if the processing time for a given batch job exceeds a threshold value.

19. A method comprising:
receiving a real-time stream of data records;
processing a first portion of the data records in a first batch job to produce resulting data, the resulting data being derived from the first portion of the data records as a result of the processing; and
processing a second portion of the real-time data in a subsequent batch job that is initiated by completion of the first batch job, the second portion of the real time data records including data records collected during processing of the first batch job.

20. The method of claim 19 wherein the real-time stream of data records includes records from a first file from a first search engine server, and records from a second file from a second search engine server.
